(19) United States
(12) Patent Application Publication
(10) Pub. No.: US 2004/0253481 A1
(43) Pub. Date: Dec. 16, 2004

(54) Multi-layer magnetic medium having a dense magnetic upper layer

(76) Inventors: Mark D. Larson, Maplewood, MN (US); Stephen R. Ebner, Stillwater, MN (US); David C. Lowery, Roberts, WI (US); Ryosuke Isobe, Superior, CO (US)

Correspondence Address: Imation Corp., PO Box 64898, St. Paul, MN, 55164-0898, US

(21) Appl. No.: 10/459,812

(22) Filed: Jun. 12, 2003

(51) Int. Cl. B32B 19/00

(52) U.S. Cl. 428/693; 428/694 BN

(57) ABSTRACT

The magnetic recording medium includes a non-magnetic substrate having a front surface and a back surface. Coated on the front surface of the substrate is a lower support layer, or sub-layer, and at least one magnetic upper layer which together comprise the front coating. The magnetic upper layer contains a primary magnetic particulate pigment and a binder system therefor. The topmost magnetic upper layer is compressed, yielding a dense coating, with less than 14% porosity, and has a thickness of from about 0.02 micron to about 0.3 micron. The lower support layer comprises a nonmagnetic or soft magnetic pigment particle, and a binder system therefor. A back coating is formed on the back surface of the substrate. The magnetic medium of the invention has fewer than 400 tape dropouts per square inch at a 60% threshold, and fewer than 30 dropouts per square inch at a 40% threshold.

### THE FIELD OF THE INVENTION

The present invention relates generally to magnetic recording media such as a magnetic tape, more specifically to a multi-layer magnetic medium having a thin dense magnetic upper layer providing a magnetic recording medium which provides superior tape drop-out performance, especially with media meeting Linear Tape Open specifications according to ECMA International Standard 319.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, magnetic recording media generally comprise a magnetic layer coated onto at least one side of a non-magnetic substrate (e.g., a film for magnetic recording tape applications).

In certain designs, the magnetic coating (or “front coating”) is formed as a single layer directly onto a non-magnetic substrate. In an effort to reduce the thickness of this magnetic recording layer, an alternative approach has been developed to form the front coating as a dual-layer construction, including a support layer (or “lower layer”) on the substrate and a reduced-thickness magnetic layer (or “upper layer”) formed directly on the support or lower layer. With this construction, the lower layer is typically non-magnetic or substantially non-magnetic, generally comprised of a non-magnetic powder and a binder. Conversely, the upper layer comprises a magnetic metal particle powder or pigment dispersed in a binder.

Magnetic tapes may also have a backside coating applied to the opposing side of the non-magnetic substrate in order to improve the durability, electrical conductivity, and tracking characteristics of the media. As with the front coatings, the backside coatings are typically combined with a suitable solvent to create a homogeneous mixture which is then coated onto the substrate, after which the coating is dried, calendered if desired, and then cured.

Linear Tape-Open (LTO) technology seeks to provide open-format, high-performance tape storage products that enhance reliability and versatility in, e.g., the network tape storage environment. LTO technology, being open format, provides users with multiple sources of product and media, and enables compatibility between the offerings of different vendors. The ULTRIUM® format is a high-capacity implementation of LTO technology. Other technologies are well-established and known in the art, e.g., the Quantum Corporation digital linear tape formats including DLT 4000, DLT 7000, and DLT 8000 (also known as DLT4, DLT7 and DLT8) drives and media.

The binder system, the lubricants, the method of forming a dispersion from the ingredients, the level of cleanliness around the coating head, the smoothness of the tape, the number, frequency and heights of protuberances on the surface affect the performance of magnetic media. The performance of magnetic media is often measured by measuring the number of dropouts per square inch of media. A dropout is an instantaneous loss of recorded signal due to imperfections in the tape. The tester can be programmed to detect varying degrees of signal loss, called thresholds. Most of these defects result in an increase in the separation between the head and the media and result in what is known as spacing loss. The tester writes a single, continuous monotone at a fixed, but specifiable, density and monitors the amplitude of the recorded signal. The number, size and frequency of areas of signal loss are recorded and reported as dropouts per square inch (DPSI); dropouts are typically reported for 40% and 60% threshold levels. A 40% threshold means that only 40% of the original signal remains. The magnetic uniformity of the coating has a substantial effect on the dropouts in the coated tape. Slit edge quality and debris produced during slitting also affect dropouts. Burnishing of the tape after slitting and the method of burnishing can also be optimized to reduce the number of dropouts. The signal loss can be due to any one or more of the following: magnetic voids, debris, surface defects, or coated-in defects. Dual-layer magnetic media, and new tape technologies designed to yield improved sound must be substantially free of defects.

It would, therefore, be desirable to have a magnetic recording medium which has a high density/optimized porosity magnetic layer for improved magnetic performance, while also exhibiting reduced tape dropouts.

### SUMMARY OF THE INVENTION

The invention provides a magnetic recording medium having a magnetic upper layer with enhanced particle density. In a preferred embodiment, the invention formulation is adapted to satisfy standards for Linear Tape Open (LTO) Ultrium™ media.

Specifically, the magnetic recording medium includes a non-magnetic substrate having a front surface and a back surface. Coated on the front surface of the substrate is a lower support layer, or sub-layer, and a magnetic upper layer which together comprise the front coating. The lower support layer comprises a non-magnetic iron oxide, e.g., hematite. The magnetic upper layer contains a primary metallic particulate pigment and a binder system therefor. The front coating is compressed, yielding a dense coating, with low porosity, and the upper layer has a thickness of from about 5 microinches to about 10 microinches. A back coating is formed on the back surface of the substrate which comprises primarily carbon black dispersed in a binder. The magnetic medium of the invention has fewer than 400 tape dropouts per square inch at a 60% threshold, and fewer than 30 dropouts per square inch at a 40% threshold.

In another aspect of the invention, a method is provided for making a dual-layer magnetic medium employing in-line calendering the coated substrate using opposed rolls, at least one of the rolls being a generally compliant roll, and subsequently off-line calendering the coated substrate using opposed, generally non-compliant rolls. The in-line calendering preferably includes applying the generally compliant roll to the backcoat side of the substrate, and applying an additional generally non-compliant roll to the front coat side of the substrate. The off-line calendering occurs at a nip pressure of at least about 2200 pounds per linear inch (pli), and a temperature of at least about 195° F.

These terms when used herein have the following meanings.

1. The term “coating composition” means a composition suitable for coating onto a substrate.

2. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

3. The term “dense coating” means that the particles of the magnetic metal upper layer and non-magnetic lower layer pigments in the coating are tightly packed.

4. The terms “layer” and “coating” are used interchangeably to refer to a coated composition.

5. The term “coercivity” means the intensity of the magnetic field needed to reduce the magnetization of a ferromagnetic material to zero after it has reached saturation, taken at a saturation field strength of 10,000 Oersteds.

6. The term “Oersted,” abbreviated as Oe, refers to a unit of magnetic field in a dielectric material equal to 1/μ Gauss, where μ is the magnetic permeability.

7. The term “porosity” refers to the pore volume relative to the total volume of the coating.

8. The term “calendering” refers to passing material through a nip point between two or more heated cylinders or rolls pressed together at elevated temperature and pressure for such purposes as to render the thickness uniform, to increase surface gloss or to force a top layer to impregnate a lower layer.

9. The term “in-line” means occurring in the same manufacturing line as other processes for manufacture of the magnetic recording medium.

10. The term “off-line” means that a process does not occur in the same manufacturing line as other process steps for manufacture of the magnetic recording medium.

11. The term “compliant” as it relates to calender rolls means that the calender roll cylinder surface which contacts the coated substrate has a Shore Durometer hardness of less than about 150 Shore D. This surface is generally some type of plastic material.

12. The term “non-compliant” as it relates to calender rolls means that the calender roll cylinder surface which contacts the coated substrate has a Rockwell hardness of greater than about 40. This surface is generally some type of metal material.

All weights, amounts and ratios herein are by weight, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

In a preferred embodiment, the magnetic recording medium is a dual-layer magnetic recording tape adapted to satisfy Linear Tape Open (LTO) Ultriumm requirements. Alternatively, however, the present invention includes other types of dual-layer media including other magnetic tape formats such as DLTtape™ IV, magnetic disks, etc.

The magnetic recording medium includes a non-magnetic substrate, a magnetic upper layer, a lower support layer, or sub-layer, and a back coat layer. The various components are described in greater detail below. In general terms, however, the magnetic upper layer includes a primary magnetic metal pigment and a binder for the pigment. The lower support layer includes a primary powder material consisting of particles having a coercivity of 300 Oe or less coated with an electroconductive material and an electroconductive material such as carbon black material dispersed in a-binder system.

### The Magnetic Recording Layer

In accordance with the current invention, the upper layer of the medium is a magnetic recording layer. The magnetic recording layer is a thin layer, being preferably from about 5 microinches (0.13 μm) to about 10 microinches (0.25 μm) in thickness, preferably from about 6 to about 8 microinches.

The magnetic metal particle pigments have a composition including but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length no greater than about 120 nanometers (nm), preferably no more than about 100 nm. Such pigments are readily commercially available from companies such as Toda Kogyo, Kanto Denka Kogyo, and Dowa Mining Company.

In upper layers of the magnetic medium of the invention, compression of the coating results in close tight packing of the magnetic (and other) particles to provide a dense layer of pigment. Specifically, the front coating of the invention has a porosity measurement of no more than about 14%, preferably less than about 13%, a reduction of about 18% from conventional top layers. This increased magnetic density provides improved signal amplitude and, when used with the appropriate sublayer, substrate and back coat, yields a magnetic medium exhibiting fewer than 400 tape dropouts per square inch at a 60% threshold, and fewer than 30 dropouts per square inch at a 40% threshold.

In addition to the preferred primary magnetic metal particle pigment described above, the metal particle pigment of the upper layer further includes soft spherical particles. Most commonly these particles are comprised of carbon black. A small amount, preferably less than about 3%, of at least one large particle carbon material is also included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the upper layer are small carbon particles, i.e., the particles have a particle size on the order of less than 100 nm, preferably less than about 50 nm.

The magnetic upper layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system associated with the upper layer preferably incorporates at least one binder resin, such as a thermoplastic resin, in conjunction with other resin components such as binders and surfactants used to disperse the HCA, a surfactant (or wettimg agent), and one or more hardeners. In one preferred embodiment, the binder system of the upper layer includes at least one hard resin component and at least one soft resin component in conjunction with the other binder components, e.g., a combination of a primary polyurethane resin and a vinyl chloride resin. Examples of polyurethanes include polyester-polyurethane, polyester-polyurethane, polycarbonate-polyurethane, polyester-polycarbonate-polyurethane, and polycaprolactone-polyurethane. Other acceptable vinyl chloride resins such as bis-phenyl-A-epoxy, styrene-acrylonitrile, and nitrocellulose are acceptable. Resins such as vinyl chloride-vinyl acetate copolymer, vinyl chloride-vinyl acetate-vinyl alcohol copolymer, and vinyl chloride-vinyl acetate-maleic anhydride can also be employed with the primary polyurethane binder, if desired.

In one preferred embodiment, the primary polyurethane binder is incorporated into the upper layer in an amount of 4 to 10 parts by weight, and preferably 5 to 7 parts by weight, based on 100 parts by weight of the primary upper layer pigment, and the vinyl chloride binder is incorporated in an amount of 7 to 15 parts by weight, and preferably 10 to 12 parts by weight, based on 100 parts by weight of the primary upper layer pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable. As with other ingredients, HCA may be dispersed in the binder system, or separately, and then added to the main dispersion.

The magnetic upper layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in both the upper and lower layers are preferably selected and formulated in combination.

Preferred fatty acid lubricants include stearic acid that is at least 90 percent pure. Although technical grade acids and/or acid esters can also be employed for the lubricant component, incorporation of high purity lubricant materials ensures robust performance of the resultant medium. Other acceptable fatty acids include myristic acid, palmitic acid, oleic acid, etc., and their mixtures. The upper layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination.

In a preferred embodiment, the lubricant is incorporated into the upper layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, such as various adducts of sulfuric, sulfonic, phosphoric, phosphonic, and carboxylic acids, are acceptable.

The coating composition may also contain a hardening agent such as isocyanate or polyisocyante. In a preferred embodiment, the hardener component is incorporated into the upper layer in an amount of from about 1 to about 5 parts by weight, and preferably from about 1 to about 3 parts by weight, based on 100 parts by weight of the primary magnetic pigment.

The materials for the upper layer are mixed with the primary pigment and coated atop the lower layer, which has been coated onto the substrate. Useful solvents associated with the upper layer coating material preferably include cyclohexanone (CHO), with a preferred concentration of from about 5% to about 50%, methyl ethyl ketone (MEK) preferably having a concentration of from about 30% to about 90%, and toluene (Tol), of concentrations from about 0% to about 40%. Alternatively, other ratios can be employed, or even other solvents or solvent combinations including, for example, xylene, methyl isobutyl ketone, tetrahydrofuran, and methyl amyl ketone, are acceptable.

### The Lower Layer or Sublayer

The lower layer of a dual-layer magnetic tape is essentially non-magnetic and typically includes a non-magnetic powder and a resin binder system. By forming the lower layer to be essentially non-magnetic, the electromagnetic characteristics of the upper magnetic layer are not adversely affected. However, to the extent that it does not create any adverse affect, a “soft” magnetic lower layer may be formed, containing a small amount of a magnetic powder or a large amount of magnetic powder having low coercivity and/or low magnetic moment.

The pigment or powder incorporated in the lower layer includes at least a primary pigment material and conductive carbon black. The primary pigment material consists of particles having a cbercivity of less than 300 Oe coated with an electroconductive material. Non-magnetic particles such as iron oxides, titanium dioxide, titanium monoxide, alumina, tin oxide, titanium carbide, silicon carbide, silicon dioxide, silicon nitride, boron nitride, etc., or “soft” magnetic particles having a coercivity of less than 300 Oe, can be provided in a form coated with carbon, tin, or other electroconductive material and employed as lower layer pigments. In a preferred embodiment, the primary lower layer pigment material is a carbon-coated hematite material (α-iron oxide), which can be acidic or basic in nature. Preferred alpha-iron oxides are substantially uniform in particle size, or a metal-use starting material that is dehydrated by heating and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, Sakai Chemical Industry Co., and others.

Conductive carbon black material provides a certain level of conductivity so as to prohibit the front coating from charging with static electricity and further improves smoothness of the surface of the upper magnetic layer formed thereon. The conductive carbon black material is preferably of a conventional type and widely commercially available. In one preferred embodiment, the conductive carbon black material has an average particle size of less than 20 nm, more preferably about 15 nm. The conductive carbon black is added in amounts of from about 0.5 to about 8 parts by weight, more preferably from about 1 to about 4 parts by weight, based on 100 parts by weight of the primary lower layer powder. The total amount of conductive carbon black and electroconductive coating material in the lower layer is preferably sufficient to provide a resistivity at or below 1×10⁸ ohm/cm².

The lower layer can also include additional pigment components such as an HCA. Again, the preferred HCA component is aluminum oxide, and the HCA is similar to that described above with respect to the upper layer.

The binder system or resin associated with the lower layer preferably incorporates at least one binder resin, such as a thermoplastic resin, in conjunction with other resin components such as binders and surfactants used to disperse the HCA, a surfactant (or wetting agent), and one or more hardeners. In one preferred embodiment, the binder system of the lower layer includes a combination of a primary polyurethane resin and a vinyl chloride resin similar to that discussed for the upper recording layer.

In a preferred embodiment, a primary polyurethane binder is incorporated into the lower layer in an amount of from about 4 to about 10 parts by weight, and preferably from about 6 to about 8 parts by weight, based on 100 parts by weight of the primary lower layer pigment. In a preferred embodiment, the vinyl chloride binder is incorporated into the lower layer in an amount of from about 7 to about 15 parts by weight, and preferably from about 10 to about 12 parts by weight, based on 100 parts by weight of the primary lower layer pigment.

The coating composition further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The binder system may also contain a conventional surfactant or wetting agent. Known surfactants, such as various adducts of sulfuric, sulfonic, phosphoric, phosphonic, and carboxylic acids, are acceptable.

The binder system may also contain a hardening agent such as isocyanate or polyisocyante. In a preferred embodiment, the hardener component is incorporated into the lower layer in an amount of 2 to 5 parts by weight, and preferably 3 to 4 parts by weight, based on 100 parts by weight of the primary lower layer pigment.

The lower layer may further contain one or more lubricants such as a fatty acid and/or a fatty acid ester. In a preferred embodiment, the lower layer includes the 90 percent pure stearic acid that is discussed for the upper layer. Likewise, other acceptable fatty acids for use in the lower layer include myristic acid, palmitic acid, oleic acid, etc., and their mixtures. The lower layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In a preferred embodiment, the lubricant is incorporated into the lower layer in an amount of from about 1 to about 10 parts by weight, and preferably from about 1 to about 5 parts by weight, based on 100 parts by weight parts of the primary lower layer pigment.

The materials for the lower layer are mixed with the surface treated primary pigment and the lower layer is coated to the substrate. Useful solvents associated with the lower layer coating material preferably include cyclohexanone (CHO), with a preferred concentration of from about 5% to about 50%, methyl ethyl ketone (MEK) preferably having a concentration of from about 30% to about 90%, and toluene (Tol) of concentrations from about 5% to about 90%. Alternatively, other ratios can be employed, or even other solvents or solvent combinations including, for example, xylene, methyl isobutyl ketone, tetrahydrofuran, and methyl amyl ketone, are acceptable.

### The Back Coat

The back coat is generally of a type conventionally employed, and thus primarily consists of a soft non-magnetic particle material such as carbon black or silicone dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 50 nm, whereas the secondary, large carbon component preferably has an average particle size on the order of from about 50 to about 300 nm. The back coat of the magnetic recording medium of the present invention contains from about 25 to about 50 percent small particle carbon particles based on total composition weight, preferably from about 35 to about 50 percent based on total composition weight.

Back coat pigments dispersed as inks with appropriate binders, surfactant, ancillary particles, and solvents are typically purchased from a designated supplier. Preferably, the back coat binder includes at least one of a polyurethane resin, a phenoxy resin, and nitrocellulose blended appropriately to modify coating stiffness as desired.

### Substrate

The substrate can be any conventional non-magnetic substrate useful as a magnetic recording medium support. Exemplary substrate materials useful for magnetic recording tapes include polyesters such as polyethylene terephthalate, polyethylene naphthalate (PEN), a mixture of polyethylene terephthalate and polyethylene naphthalate; polyolefins (e.g., polypropylene); cellulose derivatives; polyamides; and polyimides. In a preferred embodiment, polyethylene naphthalate (PEN) is employed.

### Process for Manufacture

The coating materials of the upper layer, lower layer, and back coat according to the present invention are prepared by dispersing the corresponding powders or pigments and the binders in a solvent. For example, with respect to the coating material for the upper layer, the primary metal particle powder or pigment and the large particle carbon materials are placed in a high solids mixing device along with certain of the resins (i.e., polyurethane binder, vinyl chloride binder, and surfactant) and the solvent, and processed for from about 1 to about 4 hours. The resulting material is processed in a high-speed impeller dissolver for about 30 to about 90 minutes, along with additional amounts of the solvent. Following this letdown processing, the resulting composition is subjected to a sandmilling or polishing operation. Subsequently, the HCA and related binder components are added, and the composition left standing for about 30 to about 90 minutes. Following this letdown procedure, the composition is processed through a filtration operation, and then stored in a mixing tank at which the hardener component and lubricants are added. The resulting upper layer coating material is then ready for coating.

Preparation of the lower layer coating material preferably entails a similar process, including high solids mixing of the primary electroconductive-coated primary lower layer pigment, the conductive carbon black material, the binder resins including the preferred primary polyurethane binder and vinyl chloride binder, and a solvent for about 2 to 4 hours.

Finally, preparation of the back coat coating material preferably entails mixing the various components, including a solvent, in a planetary mixer or similar device, and then subjecting the dispersion to a one pass sandmilling operation. Subsequently, the material is processed through a filtration operation in which the material is passed through a number of filters.

The process for manufacture of the magnetic recording medium includes an in-line portion and one or more off-line portions. The in-line portion, includes unwinding a non-magnetic substrate or other material from a spool or supply. The substrate is coated with the backcoating on one side of the substrate. Next, the backside coating is dried, typically using conventional ovens. A front coating is applied to the substrate. For the dual-layer magnetic recording media of the invention, the sublayer or support layer is applied first, directly onto the substrate, and the magnetic coating is then coated atop the support layer. Alternatively, the dual-layer front coating can occur prior to the backcoating. The coated substrate is magnetically oriented and dried, and then proceeds to the in-line calendaring station. According to one embodiment called compliant-on-steel (COS), in-line calendering uses one or more in-line nip stations, in each of which a steel or other generally non-compliant roll contacts or otherwise is applied to the magnetically coated side of the substrate, and a rubberized or other generally compliant roll contacts or otherwise is applied to the backcoated side. The generally non-compliant roll provides a desired degree of smoothness to the magnetically coated side of the substrate. Alternately, the in-line calendering is called steel-on-steel (SOS), meaning both opposing rolls are steel. The process may also employ one or more nip stations each having generally non-compliant rolls. After in-line calendaring, the substrate or other material is wound. The process then proceeds to an off-line portion which occurs at a dedicated stand-alone machine. The coated substrate is unwound and then is calendered. The off-line calendering includes passing the coated substrate through a series of generally non-compliant rollers, e.g., multiple steel rollers, although materials other than steel may be used. The coated, calendered substrate then is wound a second time. The wound roll is then slit, burnished, and tested for defects according to methods known in the industry.

Measurement of front coating porosity was done by using nitrogen porosimetry (an extension of the BET surface area measurement technique). Porosimeters, such as the Micromeritics 2405 Porosimeter are available from Micromeritics Instrument Corporation, Norcross, Ga. Porosimetry was measured on the entire tape construction, returning a porosity value in units of pore volume (cubic centimeters) per unit total sample weight (grams). The backcoating contribution to porosity was deemed insignificant as the backcoating was essentially non-porous. The porosity value was then converted to a front coating void fraction by dividing this porosity value by the sample's total front coating volume. This front coating volume was determined by measuring the length, width, and thickness of the front coating for the porosity measurement sample mass.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A multi-layer linear magnetic recording tape medium comprising a non-magnetic substrate having a front side and a back side, at least one lower support layer formed over the front side and at least one magnetic upper layer formed over said at least one lower layer comprising magnetic pigment particles and a binder system therefor, wherein a topmost magnetic layer has a porosity of less than about 14% where %=void volume/topmost magnetic layer volume, and a thickness of from about 0.02 micron to 0.3 micron,
wherein the linear magnetic recording tape medium exhibits fewer than 400 tape dropouts per square inch at a 60% threshold, and fewer than 30 dropouts per square inch at a 40% threshold.

2. A multi-layer linear magnetic recording tape medium according to claim 1, wherein said topmost magnetic layer has a thickness of from about 0.12 micron to about 0.20 micron.

3. (Canceled)

4. A multi-layer line or magnetic recording tape medium according to claim 1, wherein said binder system comprises a polyurethane resin.

5. A multi-layer linear magnetic recording tape medium according to claim 1, wherein said binder system comprises a vinyl chloride resin.

6. A multi-layer linear magnetic recording tape medium according to claim 5, wherein said vinyl chloride comprises at least one epoxy group and at least one sulfonate group.

7. A multi-layer linear magnetic recording tape medium according to claim 1, wherein said topmost magnetic upper layer further comprises less than about 2% of at least one large carbon particle martial having a particle size of from about 50 to about 500 nm.

8. A multi-layer linear magnetic recording tape medium according to claim 1, wherein said topmost magnetic upper layer has a porosity of from about 10 to about 14%.

9. A multi-layer linear magnetic recording tape medium according to claim 1, wherein at least one lower layer comprises a magnetic particle having a coercivity of less than about 300 Oe.

10. A multi-layer linear magnetic recording tape medium according to claim 9, wherein at least one lower layer squareness ratio is less than 0.6.

11. A muli-layer linear magnetic recording tape medium according to claim 9, wherein at least one lower layer further includes a fatty acid ester lubricant, a fatty acid lubricant, and a conductive carbon black material dispersed in binder.

12. A multi-layer linear magnetic recording tape medium according to claim 11, wherein said conductive carbon black comprises less than about 5 weight percent of the alpha-iron pigment of at least one lower layer.

13. A multi-layer linear magnetic recording tape medium according to claim 1, wherein said substrate is formed from a compound selected from the group consisting of polyaramide, polyimide, poly(ethlene naphthalate), and poly(etbylene terephthalate).

14. A multi-lay or linear magnetic recording tape medium according to claim 13, wherein said substrate comprises poly(ethylene naphthalate).

15. A multi-layer linear magnetic recording tape medium according to claim 1, wherein said medium is manufactured using a coating operation and a first and second calendering steps, the first calendering step being in-line with the coating operation, and the second calendaring being an off-line calendering step.

16. A multi-layer linear magnetic recording tape medium according to claim 15, wherein said in-line calendering step employs at least one set of two opposing rolls, at least one set of opposing rolls being a generally non-compliant roll and at least one generally compliant roll.

17. A multi-layer linear magnetic recording tape medium according to claim 16, wherein said compliant roll is applied to a side of the substrate having the backcoating, and the generally non-compliant roll is applied to a side of the substrate having the front coating.

18. A multi-layer linear magnetic recording tape medium according to claim 15, wherein said off-line calendering step employs at least two opposing rolls, said rolls being generally non-compliant rolls.

19. A multi-layer linear magnetic recording tape medium according to claim 18, wherein the surfaces of said non-compliant opposing rolls are comprised of metal.
